(19) United States
(12) Patent Application Publication
(10) Pub. No.: US 2005/0125538 A1
(43) Pub. Date: Jun. 9, 2005

(54) Assigning logical storage units to host computers

(75) Inventor: Ahmad H. Tawil, Round Rock, TX (US)

Correspondence Address: BAKER BOTTS, LLP, 910 LOUISIANA, HOUSTON, TX, 77002-4995, US

(73) Assignee: DELL PRODUCTS L.P.

(21) Appl. No.: 10/727,215

(22) Filed: Dec. 3, 2003

(51) Int. Cl. G06F 15/173

(52) U.S. Cl. 709/226

(57) ABSTRACT

Methods, systems, and computer programs are disclosed for assigning logical storage units to host computers in an information handling system. The method includes associating an application program to one or more storage units and assigning each storage unit to an associated host computer.

### FIELD OF THE INVENTION

This invention relates, in general, to information handling systems, and more particularly, to an information handling system that may assign logical storage units to host computers.

### BACKGROUND OF THE INVENTION TECHNOLOGY

An information handling system generally processes, compiles, stores, and/or communicates information or data for business, personal, or other purposes thereby allowing user to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include a Storage Area Network (SAN). The architecture of a SAN may include one or more RAID controllers. The physical storage included in the SAN may be divided into one or more logical units. Typically each logical storage unit of the SAN may be accessed by one or more servers. If a server is granted access to a logical storage unit, all applications on the server are generally given access to the device. In some implementations of an information handling system, it may be necessary or desirable to limit the granted access to one or more particular applications on a server.

### SUMMARY OF THE INVENTION

In general, this invention features a method for assigning one or more storage units to one or more host computers in an information handling system. The information handling system may include one or more storage units. Each of the storage units may have a storage unit identifier. Each of the host computers may include one or more applications. Each of the one or more application may include an application identifier. The method includes creating an association module. The association module may associate one or more application identifiers and one or more storage unit identifiers to form one or more associations. For each of the one or more associations, the method may assign each storage unit identified by each storage unit identifier to each host computer having the application identified by each associated application identifier.

In general, in another aspect, this invention features a method for installing an application in a host computer of an information handling system. The information handling system may include one or more storage units. The application may include an application identifier. The method may include booting the host computer. The method may also include selecting an application identifier. The method may further include assigning one or more of the one or more storage units to the host. The assigned one or more storage units being associated with the application identifier to form an association. The method may also include installing the application on the host computer.

In general, in another aspect, this invention features an information handling system for assigning one or more storage units to one or more host connections. The information handling system may include one or more host computers having one or more applications, a storage medium interfaced with the one or more host computers, an association module, and a control module in communication with the storage medium and the one or more host connections. Each of the one or more applications have an application identifier. The storage medium may include one or more storage units. Each storage unit may have a storage identifier. The association module may associate one or more application identifiers and one or more storage unit identifiers to form an association. The control module may perform operations including associating one or more application identifiers and one or more storage unit identifiers to form an association; and for each association, assigning each storage unit identified by each storage unit identifier to each host having the application identified by each associated application identifier.

One technical advantage of the disclosed systems and methods for assigning logical storage units to host computers is that access to a LUN need not be granted to all applications included in a host computer. This approach may be a secure approach that enhances privacy issues associated with a storage device.

Another technical advantage of the disclosed systems and methods for assigning logical storage units to host computers is an enhanced virtualization of a storage device. Logical units of a storage device may be assigned to hosts that include specific application programs.

Other features and advantages will become apparent from the description and claims that follow.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a diagram of a system for assigning logical storage units to one or more application programs;

FIG. 2 is a flow diagram of a method for selecting and installing application programs on an information handling system;

FIG. 3 is a flow diagram of a method for selecting a port name associated with an application;

FIG. 4 is a diagram of another system for assigning logical storage units to one or more application programs; and

FIG. 5 is a flow diagram of a method for assigning logical storage units to one or more application programs.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention as defined by the appended claims are intended to be covered.

### DETAILED DESCRIPTION OF SPECIFIC EMBODIMENTS

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The available physical storage in a Storage Area Network (SAN) may be very large. For example, a SAN may provide a Terabyte or more of storage. The physical storage of a SAN may typically be divided into logical units. Each logical unit may be referred to by a logical unit number or LUN. In some example systems a LUN may provide a Megabyte or more of storage.

A server in a Fibre Channel (FC) Storage Area Network (SAN) environment may be connected to a FC fabric through a Host Bus Adapter (HBA). A HBA includes both a port and a node. World Wide Names (WWN) may be assigned to the HBA node and to the HBA port. Typically the WWN of an HBA node is the same as the WWN of a HBA port.

LUNs in a FC-SAN environment are usually assigned to servers and not to specific application programs executed by a server. LUNs may be assigned to a server based on the WWN of the node of the associated HBA (or equivalently assigned based on the WWN of the port of the associated HBA if the port name is equal to the node name of the HBA connection). This approach, however, may not be suited for server provisioning in an environment where a user prefers to dynamically run one application at one time and another application at another time while preventing data from being accessed by other applications on the same server.

In general, the disclosed systems and methods include assigning LUNs to application programs or to instances of a server. By varying the WWN of the port of the HBA connection and without changing the WWN of the node of the HBA connection, an identifier of an HBA connection may be created with a finer level of granularity than an identifier based only on the WWN of the node of the HBA connection. For example, each application program to be executed by a server (or an instance of a server) may be associated with a WWN of a port of an HBA connection. Using this approach, an HBA connection may be identified by the combined WWN of its port and its node.

One embodiment of assigning a LUN to an application uses an association between an application, a server, and storage. Such an association may be established using the WWN of the HBA port. For example, without changing the node name of the HBA connection, an HBA port name may form an association with an application. The format of a WWN includes vender unique fields. The contents of a vender unique field may be varied to generate multiple port names. In conjunction with the HBA node name, a particular port name of an HBA connection may be used to make the association among an application, the HBA connection, the storage devices and LUNs on the same server.

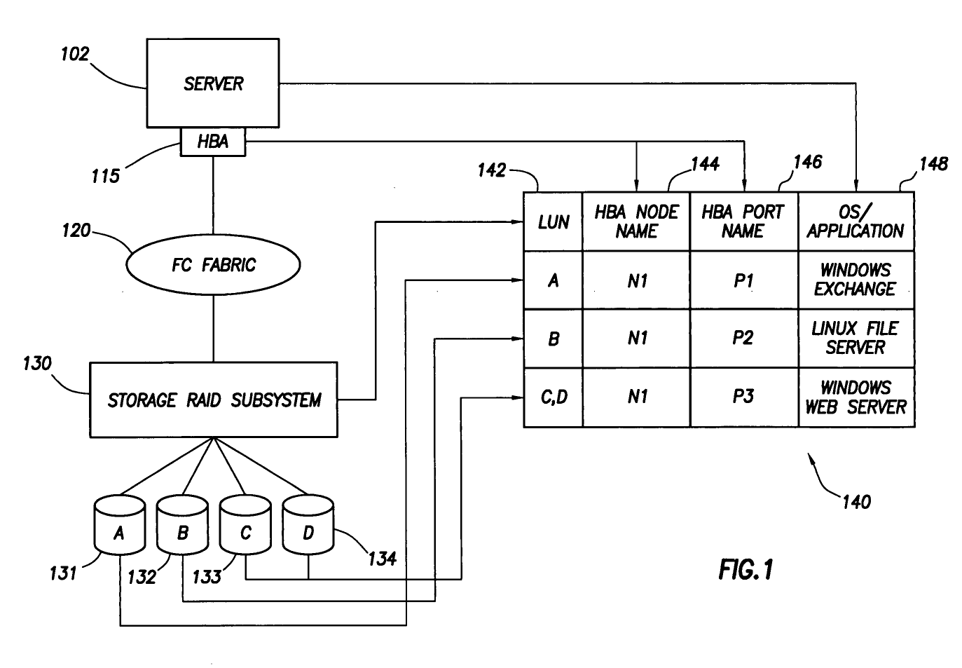

FIG. 1 depicts one example system for assigning LUNs to multiple OS/Applications on the same server. The example system includes a server 102 and a host bus adapter (HBA) 115. HBA 115 is connected or coupled to a fiber channel fabric 120. The fiber channel fabric 120 may be coupled or connected to a storage RAID subsystem 130. The storage RAID subsystem includes physical disk drive space. The physical disk drive space may include one or more LUNs. For example, the embodiment shown in FIG. 1 includes four LUNs: LUN A 131, LUN B 132, LUN C 133, and LUN D 134.

Controlling access to the storage device (and alternatively, assigning LUNs to host computers) may be accomplished by LUN masking. LUN masking may be performed at the server 102, at the storage subsystem 130, or at a device through which the I/O passes. To enable LUN masking, a table describing the associations among the LUNs, HBA node name, and HBA port name may be created. For example, Table 140 includes or defines a relationship or an association among one or more LUNs (column 142), a host bus adapter node name (column 144) and a host bus adapter port name (column 148). Table 140 may be included as part of an association module that forms an association between the application and the LUN. In this example, all LUNs are assigned to the same node name, and each LUN is assigned to a specific port name. Each port name may be associated to a specific OS/Application. This association between a port name and an OS/Application should be available at boot time since the port name is chosen at boot time and the OS/Application selection may require the system to be rebooted. If only one HBA node name exists in an information handling system, an OS/Application may be identified by the specific port name. Otherwise, if more than one HBA node name exists in an information handling system, then an OS/Application may be identified by the combination of a node name and a port name on each specific HBA connection.

In one example, the host bus adapter node name 144 includes 64 bits. Although the HBA node name 144 is typically the same as the 64 bit HBA port name 146, variations in the HBA port name 146 provides a finer level of granularity than that provided by only the HBA node name 144. For example, instead of identifying the server through the HBA node name 144, a combined addressing scheme using a doublet comprising the HBA node name and HBA port name increases the number of addressable identifiers available for server 110. Consequently, an OS/Application may be identified using HBA node name 144 and HBA port name 146.

As shown in Table 140 of FIG. 1, LUN A is assigned to the Window Exchange application, which is executed by the server with HBA node name N1 and HBA port name P1. Moreover, LUN B is assigned to the same server, but assigned only to the LINUX file server as shown in column 148. The LINUX file server is associated with the HBA port name P2. Finally, LUNs C and D are assigned to a Windows Web Server application executed by the server with node name N1. In this example, the windows web server is associated with the HBA port name P3.

Table 140 is created or updated during the process of boot and storage device initialization. During initialization, the HBA performs a login operation with the storage RAID subsystem to establish a SCSI session. The login information contains the HBA name as well as the port name. LUN masking in the storage subsystem may use this information to logically assign LUNs to the server. Without changing this process to assign LUNs to servers, the same process can be used to assign LUNs to various instances of the server or application by changing the HBA port name. Changing the HBA port name can be accomplished via BIOS and/or via online API to the HBA to activate the port name associated with certain OS/application to be used on the next server reboot.

In an alternate example, association table 140 includes fields for associating or identifying LUNs (142), for associating or identifying the HBA node name (144), and for associating or identifying the HBA port name (146). In this example, Table 140 does not include a field for associating or identifying the OS/Application. Rather during boot up, the appropriate port name is selected so that an application requesting access to the storage subsystem may be associated or identified by the selected port name. In another example, more than one HBA node name may be included in an information handling system. Under this condition, the application requesting access to the storage subsystem may be identified by the selected port name and the node name associated with the host that is executing the application.

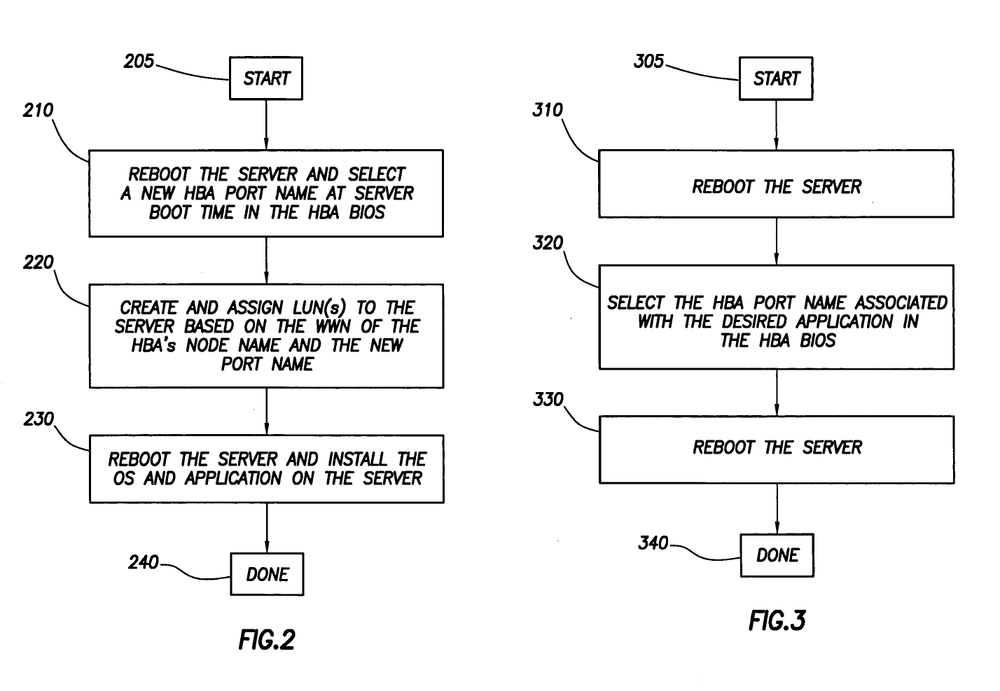

Turning to FIG. 2, a method for building or creating a table 140 of FIG. 1 and installing application onto a host computer is shown in FIG. 2. Here the method starts at Block 205. At Block 210, the server is rebooted, and an HBA port name is selected during server boot time in the HBA BIOS. The associated application may be identified by the selected HBA port name. Or alternatively the application may be identified by the selected HBA port name and the associated HBA node name of the HBA connection. One or more LUNs may be created and assigned to the server (or host computer) based on the WWN of the HBA's node name and now new WWN port name (block 232). Finally, at block 230, the server is rebooted and the OS and/or Application are installed on the server. The method terminates at block 240.

A method for choosing an application is shown in FIG. 3. The method starts at 305. The server (or host) may be rebooted at Block 310. Next the HBA port name associated with desired application may be selected in the HBA BIOS at Block 320. The server is rebooted at Block 330 in the method terminates at Block 340. The systems and methods described in this invention can be automated using Software tools to configure the HBA information and dynamically reload the server with a different instance of the OS/application along with maintaining port name information and its association with the OS/application.

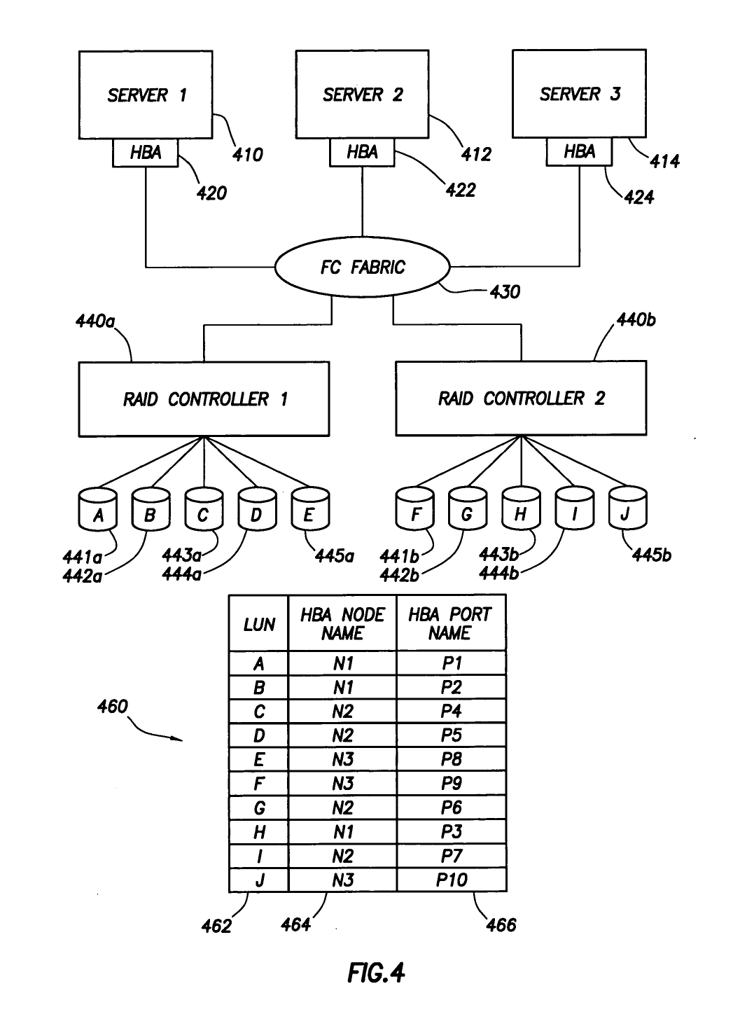

FIG. 4 depicts an information handling system that includes three servers, Server 1-410, Server 2-412, and Server 3-414. Each of the three servers includes an HBA Port Connection (420, 422, 424). Each HBA port connection is connected to a fiber channel fabric 430. The fiber channel fabric is also connected to RAID controllers, RAID Controller 1-440 and RAID Controller 2-440. Each RAID controller includes five LUNs (441a, 442a, 443a, 444a, 445a and 441b, 442b, 443b, 444b, 445b). As shown in Table 460, each of the LUNs A-J are associated with an HBA node name and an HBA port name. In this example, the HBA node name identifies one of three servers. For example, Server 1 has the node name N1, Server 2 has the node name N2, and Server 3 has the node name N3. In this example, an application may be identified by an associated HBA node name (464) and an associated HBA port name (466). To move the application identified as N1,P1 from server 410 to 412, LUN A can be reassigned by changing the association of the application in Table 460 for LUN A from N1,P1 to N2,P11.

The concept of storage virtualization is illustrated in FIG. 4. In FIG. 4, LUNs may be assigned to various servers depending upon the selection of an HBA node name and an HBA port name. Consequently, a storage unit is not tied to a specific server. As shown in FIGS. 2 and 4, storage virtualization also occurs as the result of assigning logical storage units to applications within a server or host. Implementation of the disclosed systems and methods may yield enhanced storage virtualization, both across and within servers.

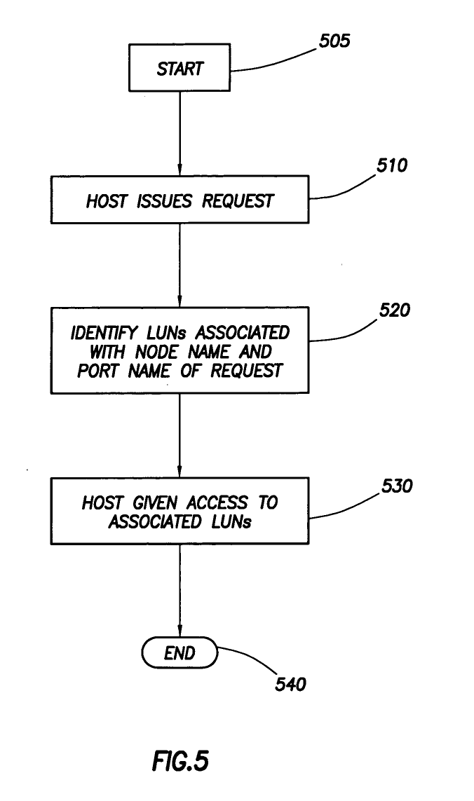

One implementation of a method to assign LUNs to an application is shown in FIG. 5. The method begins at block 505. A server or host issues a request to the storage sub-system (block 510). The request issued by the host includes a node name and a port name of the HBA connection of the host that issued the request. LUN masking may be performed at the storage subsystem in response to the request (block 520). For example, an association module may scan an association table to identify the LUNs associated with the node name and the port name included in the request. The host computer may then access the LUNs that have been associated with the node name and port name of the HBA connection of the host that issued the command or request (block 530). Alternatively, the associated LUNs may be assigned to the host computer having the node name and the port name of the HBA connection of the host that issued the command or request (block 530). As a result, the disclosed systems and methods limit access of the LUNs to one or more host computers that have executed, desired or associated application (or alternatively, the method may assign LUNs to host computers). The method ends at block 540.

The disclosed systems and methods may also be implemented to enhance secure connections to one or more data storage units. For example, LUNs may be assigned to hosts having and executing a particular application. The same host running a different application program could be denied access to one or more LUNs.

The invention, therefor, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A method for assigning one or more storage units to one or more host computers in an information handling system, the method comprising:
associating one or more application identifiers and one or more storage unit identifiers to form one or more associations, each application identifier identifying an application of a host computer, each storage unit identifier identifying a storage unit of the information handling system; and
for each of the one or more associations, assigning each storage unit identified by each storage unit identifier to each host computer having the application identified by each associated application identifier.

2. The method of claim 1, wherein the association module includes a mapping table having one or more rows, each row of the mapping table including a storage unit identifier, and an application identifier, each row of the mapping table forming an association of a storage unit and an application.

3. The method of claim 1, wherein each application identifier includes a node name and a port name of a host bus adapter of the host computer having the application identified by the application identifier.

4. The method of claim 3, wherein the node name includes a World-Wide Name (WWN).

5. The method of claim 3, wherein the port name includes a World-Wide Name (WWN).

6. The method of claim 1, wherein the storage unit identifier includes a logical unit number (LUN).

7. A method for permitting access to one or more storage units in an information handling system, the method comprising:
associating an application identifier and a storage unit identifier to form an association, each application identifier identifying an application of a host computer, each storage unit identifier identifying a storage unit of the information handling system;
receiving, at one of the one or more storage units, a request from a host, the request including a request application identifier; and
permitting access to the one of the one or more storage units if the identifier of the one of the one or more storage units, and the request application identifier have an association in the association module.

8. The method of claim 7, wherein the association module includes a mapping table having one or more rows, each row of the mapping table including a storage unit identifier, and an application identifier, each row of the mapping table forming an association of a storage unit and an application.

9. The method of claim 7, wherein each application identifier includes a node name and a port name of a host bus adapter of the host computer having the application identified by the application identifier.

10. The method of claim 9, wherein the node name includes a World-Wide Name (WWN).

11. The method of claim 9, wherein the port name includes a World-Wide Name (WWN).

12. The method of claim 7, wherein the storage unit identifier includes a logical unit number (LUN).

13. The method of claim 7, wherein creating an association module includes
selecting an application identifier; and
assigning one or more of the one or more storage units to the host computer having the application identified by the application identifier.

14. A method for installing an application in a host computer of an information handling system, the information handling system including one or more storage units, the method comprising:
booting the host computer, the host computer including an application, the application having an application identifier;
selecting an application identifier;
assigning one or more of the one or more storage units to the host, the assigned one or more storage units being associated with the application identifier to form an association; and
installing the application on the host computer.

15. The method of claim 14, further comprising:
booting the host computer;
selecting an application identifier, the application identifier being associated with a desired application;
configuring the host computer to include the application identifier; and
booting the host computer.

16. An information handling system for assigning one or more storage units to one or more host connections, the system comprising:
one or more host computers having one or more applications, each of the one or more applications having an application identifier;
a storage medium interfaced with the one or more host computers, the storage medium including one or more storage units, each storage unit having a storage identifier;
an association module associating one or more application identifiers and one or more storage unit identifiers to form an association;
a control module in communication with the storage medium and the one or more host connections, the control module performs operations comprising:
associating one or more application identifiers and one or more storage unit identifiers to form an association; and
for each association, assigning each storage unit identified by each storage unit identifier to each host having the application identified by each associated application identifier.

17. The system of claim 16, wherein the association module includes a mapping table having one or more rows, each row of the mapping table including a storage unit identifier and an application identifier, each row of the mapping table forming an association of a storage unit and an application.

18. A computer program for assigning one or more storage units in an information handling system to one or more host connections, the computer program comprising executing instructions that cause an information handling system to:
associate one or more application identifiers and one or more storage unit identifiers to form an association, each application identifier identifying an application of a host computer, each host computer having one or more host connections, each storage unit identifier identifying one or more storage units of the information handling system; and
for each association, assigning each storage unit identified by each storage unit identifier to each host having the application identified by each associated application identifier.

19. The computer program of claim 18, wherein the association module includes a mapping table having one or more rows, each row of the mapping table including a storage unit identifier and an application identifier, each row of the mapping table forming an association of a storage unit and an application.

20. A data structure for assigning one or more storage units of an information handling system to one or more host connections, the information handling system including one or more host computers having one or more applications, each of the one or more applications having an application identifier, each of the one or more storage units having a storage identifier, the data structure comprising:
a mapping table having one or more rows, each row of the mapping table including a storage unit identifier and an application identifier, each row of the mapping table forming an association of a storage unit identified by the storage identifier and a host having the application identified by each associated application identifier.
